(19) United States
(12) Patent Application Publication
(10) Pub. No.: US 2026/0184877 A1
(43) Pub. Date: Jul. 2, 2026

(54) METHOD FOR RECYCLING POLYOLEFIN-BASED PLASTICS IMPLEMENTING A SIZE-EXCLUSION SIMULATED MOVING BED DEVICE

(71) Applicant: IFP Energies Nouvelles, Rueil-Malmaison (FR)

(72) Inventors: Damien LEINEKUGEL LE COCQ, Rueil-Malmaison Cedex (FR); Mathilde SIBEAUD, Rueil-Malmaison Cedex (FR); Alexandra CHAUMONNOT, Rueil-Malmaison Cedex (FR); Alexandra BERLIOZ-BARBIER, Rueil-Malmaison Cedex (FR); Guillaume BLANCKE, Rueil-Malmaison Cedex (FR); Marc JACQUIN, Rueil-Malmaison Cedex (FR)

(73) Assignee: IFP Energies Nouvelles, Rueil-Malmaison (FR)

(21) Appl. No.: 19/132,075

(22) PCT Filed: Nov. 23, 2023
(86) PCT No.: PCT/EP2023/082786

§ 371 Date: May 22, 2025

(30) Foreign Application Priority Data
Dec. 1, 2022 (FR) FR2212607

(51) Int. Cl. C08J 11/06; B01D 15/18; B01D 15/34; B01D 15/42

(52) U.S. Cl. CPC C08J 11/06; B01D 15/1821; B01D 15/34; B01D 15/426; C08J 2323/06

(57) ABSTRACT

A process for purifying a plastic feedstock to obtain a stream of purified polyolefins, by:
a) dissolution by bringing the plastic feedstock into contact with a dissolution solvent; then
b) extraction by size exclusion, implementing beds of a size exclusion solid in series and fed with the polymer solution obtained from a) at an injection point (F) and with an eluent at an injection point(S) and implementing a withdrawal of an extract at a withdrawal point (E) and a withdrawal of a raffinate including a purified polymer solution at a withdrawal point (R),
the injection and withdrawal points being distinct and shifted over time by one bed according to a determined frequency; then
c) polymer-solvent separation, to obtain a stream of purified polyolefins; and
furthermore a device for performing step b) and a device for performing the purification process.

### TECHNICAL FIELD

The invention relates to the field of recycling polyolefin-based plastics, in particular (co) polypropylene and/or (co) polyethylene, in order to obtain a purified polyolefin stream which may be economically upgraded, for example in the manufacture of new plastic objects. More particularly, the present invention relates to a process for treating a plastic feedstock, in particular obtained from plastic waste, comprising polyolefins, in particular (co) polypropylene and/or (co) polyethylene. Said process advantageously comprises dissolving the polyolefins in a solvent, in particular an organic solvent, in particular a hydrocarbon solvent, at least one step of purification of the polymer solution obtained, by extraction in a simulated moving bed by size exclusion, so as to at least partly remove the impurities, in particular the additives conventionally used in plastic-based materials, and a step of separation of the polymer and the solvent, to recover a stream of purified polyolefins, so as to be able to reuse the purified polyolefins in the manufacture of new objects and thus to economically upgrade the plastic feedstock, in particular obtained from waste.

### PRIOR ART

Plastics recycling is a major environmental challenge for the coming century. There are several approaches for the recycling and economic upgrading of plastics obtained from collection and sorting channels.

First of all, there is “mechanical” recycling: mechanical recycling enables the partial reuse of certain waste materials either directly (after melting and then forming the thermoplastics) in new objects, or by mixing the mechanically sorted plastic waste streams with virgin polymer streams. This type of economic upgrading is limited since mechanical sorting makes it possible to improve the purity of a plastic stream of a given type of polymer but it does not generally make it possible to sufficiently remove the impurities that are at least partly trapped in the polymer matrix, for instance the additives, such as the fillers, dyes, pigments and metals used as a mixture with the polymers to give the material the desired properties.

“Chemical” recycling for its part is primarily directed towards eliminating the additives and, depending on the processes applied, chemically modifying the polymeric chains of the plastics under consideration to a greater or lesser extent (for example recovering the intact polymer, depolymerizing it or obtaining mixtures of compounds comprising carbon and hydrogen obtained after non-selectively breaking the chains of various polymers). These various options involve sequences of steps that are generally complex. For example, plastic waste may undergo a pyrolysis step and the pyrolysis oil recovered, generally after purification, may be at least partly converted, for example, into olefins by steam cracking. These olefins may then be polymerized or transformed into monomers before being polymerized. This type of sequence may be suitable for feedstocks that have undergone little sorting or for sorting centre refuse but it generally requires a large consumption of energy notably due to the high temperature treatments.

Among the various possible routes, the deformulation of thermoplastic-based plastics materials, in particular of polyolefins such as (co) polypropylenes and (co) polyethylenes, appears to be virtuous: it specifically consists in dissolving the polymer in a solvent and in removing the additives without modifying the polymer chains. The conservation of the polymeric structure reduces the effort required to reuse the material and explains the good performance of this approach in particular in terms of energy consumption.

When the impurities contained in the plastic feedstock, such as the additives, are insoluble in the solvent, they may optionally be separated by solid/liquid separation, for example by filtration. However, additives that are soluble in the solvent are particularly difficult to separate out. One approach, the most conventional, may consist in separating them on the basis of specific physicochemical properties such as their polarity, solubility, boiling point, density, etc., but this may give rise to a multiplication of the purification steps given the plurality and diversity of the impurities present. The present invention proposes another approach based on exploiting the size difference, more precisely the hydrodynamic volume, between the polymer macromolecules and the molecules of the impurities such as those of the additives.

Separation based on size already exists and is commonly used as an analytical method for determining the molecular weight of polymers. This method, called size exclusion chromatography (or SEC), performed discontinuously (“in batch mode”), consists in implementing a fixed bed with several porosity levels. Small molecules explore said fixed bed as far as the smallest porosities, the associated elution times then being high, while big molecules, such as polymers, travel only through the biggest pores and exhibit short elution times, which enables selective separation of the various molecules. In so far as the additives commonly used for the formulation of plastics (colorants, plasticizers, antioxidants, stabilizers, etc.) have a size much smaller by an order of magnitude than the size of a polymer, in particular of polyolefins, the principle of size exclusion chromatography may thus be applied for the purification of plastics. However, the implementation of a process using the principle of such a chromatography is in batch mode, which may be problematic in an industrial context. Furthermore, such a process in batch mode would require a significant consumption of eluent in order to ensure efficient separation, which directly impacts the profitability, the productivity and the ecological footprint of the process.

The Simulated Moving Bed (SMB) technology, a concept invented in 1961, makes possible the continuous functioning of a discontinuous “chromatographic” process, in particular by adsorption, with an increase in the productivity and a limitation on the amount of eluent consumed, while ensuring an efficient separation. Many industrial references to this technology exist, in particular for separations by adsorption which are used in particular for the separation of xylenes with the Eluxyl® or Parex® processes (cf. the publication Simulated Moving Bed Technology: Principles, Design and Process Applications, A. E. Rodrigues, Elsevier, 2015). The only large-scale application of a size-exclusion simulated moving bed (or SMB-SEC for Simulated Moving Bed with Size Exclusion Chromatography) concerns the separation of n-paraffins from isoparaffins, the outlines of which are specified in U.S. Pat. No. 2,985,589. Recent publications mention the use of the size-exclusion simulated moving bed (SMB-SEC) technology for the fractionation of polyethylene glycols of varied molecular weights (M. T. Liang et al., J. Chromatogr. A, 2012, 1229, 107) or for the separation of proteins (E. J. Freydell et al., Chem. Eng. Sc., 2010, 65, 4701). More particularly, U.S. Pat. No. 6,551,512 proposes a method for the separation of proteins from liquid compositions, such as milk, by size exclusion in a simulated moving bed. Lastly, a publication mentions the use of SMB-SEC in a process for the recycling of materials included in the composition of WEEE (waste electrical and electronic equipment). WEEE is based on polycarbonate and also comprises poly(styrene-co-acetonitrile) (SAN) and additives such as flame retardants. It is the latter that the Weeden team seeks to separate from a ternary solution containing SAN and two flame-retardant compounds, resorcinol bis(diphenyl phosphate) and bisphenol A bis(diphenyl phosphate), in an acetone-dichloromethane solvent mixture (G. S. Weeden et al., Journal of Chromatography A, 2015, 1422, 99).

Application of the SMB-SEC technology as a method for purifying polyolefin-based plastic waste, in order to obtain a stream of purified polyolefins, in particular a stream of polypropylene, polyethylene, copolymers thereof or mixtures thereof, has never been proposed.

The present invention is thus directed towards overcoming the problems of the prior art and participating in the recycling of plastics. More particularly, it is directed towards providing an efficient, simple and economically viable process for treating a polyolefin-based plastic feedstock, in particular obtained from plastic waste, for example originating from collection and sorting channels, so as to remove at least some of the impurities contained therein, in particular at least some of the additives conventionally added to plastics, so as to be able to economically upgrade said polyolefin-based plastic feedstock. The present invention specifically seeks to efficiently separate the impurities from the polyolefins, which are included in used plastics, and to recover the purified polyolefins, in order to be able to use them, for example in the manufacture of new plastic objects, notably in place of virgin resin.

### SUMMARY OF THE INVENTION

The present invention thus relates to a process for purifying a plastic feedstock in order to obtain a stream of purified polyolefins, said process comprising:
a) a dissolution step comprising bringing the plastic feedstock into contact with a dissolution solvent, in order to obtain at least one crude polymer solution;
b′) optionally a step of separation of the insoluble materials from the crude polymer solution obtained from step a), in order to obtain at least one clarified polymer solution;
b) a step of extraction by size exclusion of the crude polymer solution obtained at the end of step a) or optionally of the clarified polymer solution obtained at the end of optional step b′), in order to obtain a purified polymer solution,
wherein said step of extraction by size exclusion implements at least one train of n fixed beds of a size exclusion solid, n being an integer greater than or equal to 4, the n beds being in series,
said train of fixed beds of step b) being fed with crude or optionally clarified polymer solution at at least one point of injection F of the polymer solution and with an eluent at at least one point of injection S of the eluent,
wherein said train of fixed beds of step b) implements at least one withdrawal of an extract at at least one point of withdrawal E of the extract, and at least one withdrawal of a raffinate at at least one point of withdrawal R of the raffinate,
wherein the points of injection of the polymer solution and of the eluent and the points of withdrawal of the extract and of the raffinate are distinct from one another and distributed so that they determine at least three, preferably four, successive main operating zones of the n fixed beds:
   a zone I of elution of the impurities, located between a point of injection of the eluent and a point of withdrawal of the extract;
   a zone II of elution of the polyolefins, located between the point of withdrawal of the extract and a point of injection of the polymer solution;
   a zone III of retention of the impurities, located between the point of injection of the polymer solution and a point of withdrawal of the raffinate; and
   optionally a zone IV, located between the point of withdrawal of the raffinate and the point of injection of the eluent,
wherein the points of injection and of withdrawal are shifted over time by one fixed bed of size exclusion solid according to a frequency determined by a predetermined permutation period,
wherein said raffinate is recovered in order to constitute, at least in part, the purified polymer solution;
c) a step of polymer-solvent separation of the purified polymer solution, in order to obtain at least one stream of purified polyolefins and at least one solvent fraction comprising dissolution solvent.

The advantage of the process of the invention is that it proposes a process for the efficient treatment of a feedstock comprising polyolefin-based plastics, especially plastic waste in particular obtained from collection and sorting channels, so as to recover the polyolefins it contains in order to be able to recycle them into any type of application. This is because the process according to the invention makes it possible to obtain a stream of purified polyolefins, in particular a stream of polypropylene, polyethylene, copolymers thereof or mixtures thereof, very advantageously less coloured than the initial plastic feedstock, indeed even colourless, and preferably deodourized. The stream of purified polymers obtained preferably has negligible contents of substances that are prohibited or regulated, for example by the REACH Regulation (cf. Annexes XIV and XVII to Regulation (EC) No 1907/2006 of the European Parliament and of the Council of 18 Dec. 2006). In particular, the stream of purified polyolefins obtained at the end of the process according to the invention very advantageously comprises a content of impurities, and in particular of additives, and a content of solvent, in particular of dissolution and/or eluent solvent, which are negligible or at least sufficiently low for the stream of purified polyolefins to be able to be introduced into any formulation of plastics in place of virgin polymer resins. For example, the stream of purified polyolefins obtained at the end of the process according to the invention advantageously comprises a content of impurities of less than or equal to 5% by weight, very advantageously less than or equal to 1% by weight, or even less than or equal to 0.5% by weight, and advantageously a content of solvent (in particular of dissolution solvent and eluent) of less than or equal to 5% by weight of solvent, preferably less than or equal to 1% by weight, with preference less than or equal to 0.1% by weight.

The process according to the invention thus proposes a simple scheme corresponding to a minimum sequence of operations, which makes it possible to remove at least some of the impurities, notably at least some of the additives, from plastic waste based on polyolefins, in particular based on polypropylene, polyethylene, copolymers thereof or mixtures thereof, and to recover purified polyolefins, advantageously comprising little or even no solvent, so as to be able to economically upgrade the plastic waste by recycling said purified polyolefins.

The invention also has the advantage of participating in the recycling of plastics and in the conservation of fossil resources, by enabling the economic upgrading of plastic waste and notably polyolefin-based plastic waste. Specifically, it allows the purification of plastic waste for the purpose of obtaining purified polyolefins with a reduced content of impurities, which are notably decolourized and deodourized polyolefins, which may be reused for forming new plastic objects. The purified polyolefin fractions obtained may thus be used directly in formulations as a mixture with additives, for example dyes, pigments or other polymers, in place of or as a mixture with virgin polypropylene or polyethylene resins or mixtures thereof, for the purpose of obtaining plastic products having aesthetic, mechanical or rheological working properties which facilitate their reuse and their economic upgrading.

The present invention also relates, according to a second aspect, to a device for extraction by size exclusion of polyolefins from a polymer solution, said device comprising:
n fixed beds of a size exclusion solid, n being an integer greater than or equal to 4, preferably of between 4 and 30, said size exclusion solid having a volume-average pore diameter of preferably between 1 and 500 nm, preferably between 2 and 100 nm, preferentially between 2 nm and 50 nm, preferentially between 3 and 30 nm, and with preference being a silica gel, a grafted silica, a carbon molecular sieve or mixtures thereof,
   the n fixed beds of the size exclusion solid being distributed in one or more column(s), the n beds being connected in series and preferably in a closed loop,
N systems for injection of the polymer solution, N systems for injection of an eluent, N systems for withdrawal of an extract and N systems for withdrawal of a raffinate, N being an integer preferably equal to n, said injection and withdrawal systems being located between two consecutive beds or optionally upstream of the first bed,
   wherein the systems for injection of the polymer solution and of the eluent and/or the systems for withdrawal of the extract and of the raffinate which are located at one and the same position are distinct or identical,
each injection and withdrawal system comprising at least one valve suitable for allowing or not allowing the passage of a stream of polymer solution and/or of eluent and/or of extract and/or of raffinate, preferably a series of on-off valves which are controlled by an automatic sequence, or a single rotary valve, so as:
   to define, at an instant t, a point of injection of the polymer solution, a point of injection of the eluent, a point of withdrawal of the extract and a point of withdrawal of the raffinate, said points of injection and of withdrawal being distinct from one another and determining at least three, preferably four, successive main operating zones of the n fixed beds:
   a zone I of elution of the impurities, comprised between a point of injection of the eluent and a point of withdrawal of the extract;
   a zone II of elution of the polyolefins, comprised between the point of withdrawal of the extract and a point of injection of the polymer solution;
   a zone III of retention of the impurities, comprised between the point of injection of the polymer solution and a point of withdrawal of the raffinate; and
   optionally a zone IV, comprised between the point of withdrawal of the raffinate and the point of injection of the eluent,
and to make possible, over time, a shifting in the points of injection and of withdrawal, synchronously or non-synchronously, according to a frequency determined by a predetermined permutation period, by one fixed bed of size exclusion solid per permutation period.

The present invention also relates, according to a third aspect, to a device for treatment of a plastic feedstock in order to obtain a stream of purified polyolefins, comprising:
dissolution means for bringing the plastic feedstock and a dissolution solvent into contact, so as to dissolve at least in part the plastic feedstock in a dissolution solvent, in order to obtain a crude polymer solution;
   optionally solid-liquid separation means suitable for separating insoluble materials in suspension in the crude polymer solution;
at least one device for extraction by size exclusion according to the invention;
means for separation of the dissolution solvent and optionally of the eluent from a stream of purified polyolefins.

### LIST OF FIGURES

FIG. 1 represents a particular embodiment of the step of extraction by size exclusion of the present invention, at a given instant t of the process, in which said step of extraction by size exclusion implements 15 fixed beds of size exclusion solid, of silica gel type, distributed in a single column, said beds being connected together in series with respect to one another and in a closed circuit, a pump located between bed No. 15 and bed No. 1 making it possible to connect bed No. 15 and bed No. 1 in series.

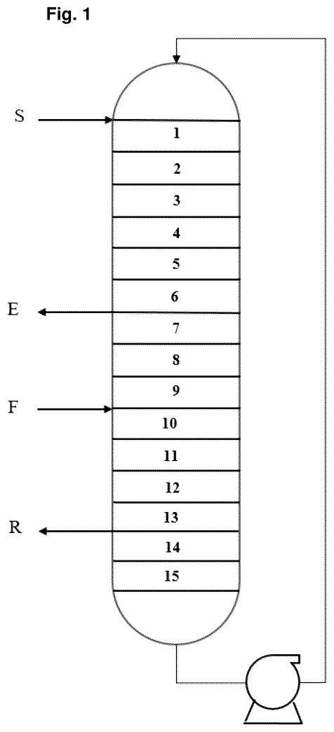

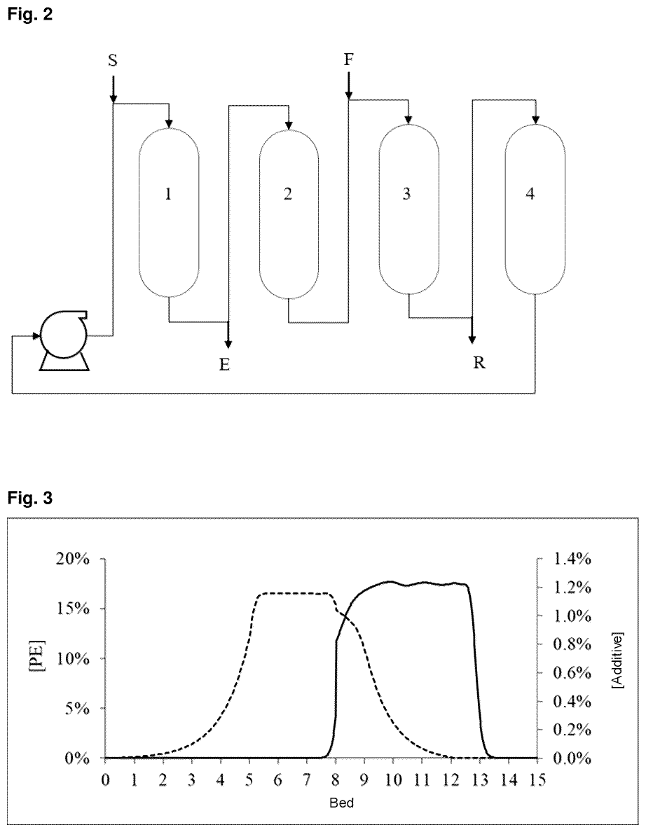

In this particular embodiment and at this instant t:
the crude polymer solution obtained from the dissolution step a) (not represented in FIG. 1) or optionally the clarified polymer solution obtained from the solid-liquid separation step b′) optionally incorporated in the process (not represented in FIG. 1) is introduced at the injection point F located between bed No. 9 and bed No. 10, these two beds being consecutive,
an eluent is introduced at the injection point S located between bed No. 15 and bed No. 1, these two beds being consecutive,
an extract, comprising at least some of the impurities present in the polymer solution which feeds the column, is withdrawn at the withdrawal point E located between bed No. 6 and bed No. 7, these two beds being consecutive,
a raffinate, composed, at least in part, of a purified polymer solution comprising the polyolefins present in the polymer solution which feeds the column, is withdrawn at the withdrawal point R located between bed No. 13 and bed No. 14, these two fixed beds being consecutive.

The combined injection and withdrawal points thus define 4 operating zones:
a zone I of elution of the impurities, located between the injection of the eluent and the withdrawal of the extract, comprising 6 beds,
a zone II of elution of the polyolefins, located between the withdrawal of the extract and the injection of the polymer solution, comprising 3 beds,
a zone III of retention of the impurities, located between the injection of the polymer solution and the withdrawal of the raffinate, comprising 4 beds, and
a zone IV, located between the withdrawal of the raffinate and the injection of the eluent, comprising 2 beds.

FIG. 2 represents another particular embodiment of the step of extraction by size exclusion of the present invention, at a given instant t of the process, in which said step of extraction by size exclusion comprises 4 fixed beds of size exclusion solid, of silica gel type, each distributed in a column (i.e. one bed per column), said columns being connected together in series with respect to one another and in a closed circuit, a pump located between column No. 4 and column No. 1 making it possible to connect column No. 4 and column No. 1 in series.

In this particular embodiment and at the instant t:
the polymer solution which feeds the step of extraction by size exclusion is introduced at the injection point F located between the column 2 and the column 3,
an eluent is introduced at the injection point S located between the column 4 and the column 1,
an extract, comprising at least some of the impurities present in the polymer solution which feeds the step of extraction by size exclusion, is withdrawn at the withdrawal point E located between the column 1 and the column 2,
a raffinate, composed, at least in part, of a purified polymer solution comprising the polyolefins present in the polymer solution which feeds the step of extraction by size exclusion, is withdrawn at the withdrawal point R located between the column 3 and the column 4.

FIG. 3 represents the concentration profile obtained in the context of Example 1, for polyethylene (PE) and the additive Irgafos® 168, by simulation along the entire length of the simulated moving bed which comprises 15 fixed beds of silica gel according to a 6/3/4/2 configuration. By convention, the injection of the eluent is located upstream of the bed 1 (and downstream of the bed 15). The concentration profile of the PE as a function of the beds is represented by a solid black line and the concentration profile of the additive Irgafos® 168 as a function of the beds is represented by the dotted line.

### DESCRIPTION OF THE EMBODIMENTS

According to the present invention, the expressions “of between . . . and . . . ” and “between . . . and . . . ” are equivalent and mean that the limit values of the interval are included in the described range of values. If such is not the case and if the limit values are not included in the described range, such a clarification will be given by the present invention.

In the present description, the expression “greater than . . . ” is understood as strictly greater, and symbolized by the sign “>”, and the expression “less than” as strictly less, and symbolized by the sign “<”. When the limit is included, this detail will be indicated by the respective expressions “greater than or equal to . . . ” (and corresponding to the sign “>”) and “less than or equal to” (corresponding to the sign “s”).

For the purposes of the present invention, the various ranges of parameters for a given step, such as the pressure ranges and the temperature ranges, may be used alone or in combination. For example, for the purposes of the present invention, a range of preferred pressure values may be combined with a range of more preferred temperature values.

Hereinafter, particular embodiments of the invention are described. They may be implemented separately or combined together, without limitation of combinations when this is technically achievable.

The terms “upstream” and “downstream” should be understood as a function of the general flow of the fluid(s) or stream(s) under consideration in the process. More particularly, the terms “upstream” and “downstream” are defined as a function of the flow of the stream which comprises the polymers to be purified, in particular the polyolefins. For example, the terms “upstream” and “downstream” are defined in the size exclusion step with respect to the stream of polymer solution, that is to say either to the feeding of said step with crude (or clarified) polymer solution or to the point of exit of the purified polymer solution (i.e. point of withdrawal of the raffinate).

The term “additives” is a term conventionally used in the field of polymers and in particular in the field of polymer formulations. The additives introduced into the polymer formulations may be, for example, plasticizers, fillers (which are organic or mineral solid compounds used for modifying the physical, thermal, mechanical and/or electrical properties of the polymer materials or for reducing the cost price thereof), reinforcing agents, dyes, pigments, plasticizers, hardeners, flame retardants, combustion retardants, stabilizers, antioxidants, UV absorbers, antistatic agents, etc.

The additives correspond to at least some of the impurities of the plastic feedstock to be treated and which the treatment process according to the invention makes it possible to at least partly remove. Other types of impurities may be present in the plastic feedstock to be treated, for example use-related impurities, for example metal impurities, paper/cardboard, biomass, polymers other than the targeted polymer(s), etc.

Thus, according to the invention, the impurities which the process according to the invention makes it possible to at least partly remove comprise the additives conventionally used in polymer formulations, in particular polyolefin-based formulations, and also possibly use-related impurities resulting from the life cycle of the plastic objects and materials, and/or resulting from the waste collection and sorting circuit. Said impurities may be impurities of metallic, organic or mineral type; they may be packaging residues, food residues or compostable residues (biomass). These use-related impurities may also comprise glass, wood, cardboard, paper, aluminium, iron, metals, tyres, rubber, silicones, rigid polymers, thermosetting polymers, household, chemical or cosmetic products, waste oils, water, etc.

According to the invention, a polymer solution is a solution comprising a dissolution solvent and at least the targeted polyolefins, in particular polypropylene, polyethylene, copolymers thereof or mixtures thereof, which are dissolved, that is to say in particular solvated and dispersed, in said dissolution solvent, the dissolved polyolefins being initially present in the plastic feedstock. The polymer solution may additionally comprise soluble impurities (which are dissolved in the dissolution solvent) and/or insoluble impurities (which are in suspension in the polymer solution; in the case of nanometric insoluble impurities, reference will then be made to colloidal solutions). Depending on the steps of the process according to the invention that are carried out, said polymer solution may thus comprise, in addition to the targeted polyolefins dissolved in the dissolution solvent, impurities in the form of insoluble particles which are advantageously in suspension in said polymer solution, soluble impurities dissolved in the dissolution solvent, and/or possibly another liquid phase that is immiscible with said polymer solution.

It is well known that the boiling point of a compound varies with the operating pressure. However, without further indication, i.e. without indication of the pressure, the boiling point of the compound under consideration, in particular of the dissolution solvent, is to be understood as the boiling point of said compound, in particular of said dissolution solvent, at atmospheric pressure (in particular equal to 0.1 MPa). Thus, the boiling point characterizing the dissolution solvent is to be understood as the boiling point of said dissolution solvent at atmospheric pressure (in particular equal to 0.1 MPa).

The invention relates to a process for purifying a plastic feedstock, preferably composed of plastic waste, and advantageously comprising polyolefins, said process comprising, and preferably consisting of:
a) a dissolution step comprising bringing the plastic feedstock into contact with a dissolution solvent, in order to obtain at least one crude polymer solution;
b′) optionally a step of separation of the insoluble materials from the crude polymer solution, in particular by solid/liquid separation of the crude polymer solution obtained from step a), in order advantageously to obtain a clarified polymer solution and preferably an insoluble fraction;
b) a step of extraction by size exclusion of the crude polymer solution obtained at the end of step a) or optionally of the clarified polymer solution obtained at the end of optional step b′), in order to obtain a purified polymer solution,
wherein said step of extraction by size exclusion implements at least one train of n fixed beds of a size exclusion solid, n being an integer greater than or equal to 4, preferably of between 4 and 30, preferentially between 8 and 24, very preferentially between 8 and 21 and with preference between 12 and 15,
advantageously the n fixed beds of the size exclusion solid being distributed in one or more column(s), preferably in M column(s), M being an integer of between 1 and the total number n of fixed beds of the exclusion solid, the n beds being in series with respect to one another and preferably in a closed loop,
said at least one train of fixed beds of step b) being fed with crude or clarified polymer solution at at least one point of injection F of the polymer solution and with an eluent at at least one point of injection S of the eluent,
wherein said at least one train of fixed beds of step b) implements at least one withdrawal of an extract at at least one point of withdrawal E of the extract, and at least one withdrawal of a raffinate at at least one point of withdrawal R of the raffinate,
the points of injection of the polymer solution and of the eluent and the points of withdrawal of the extract and of the raffinate being distinct from one another, advantageously located between two consecutive beds or optionally upstream of the first bed, and distributed so that they determine at least three, preferably four, successive main operating zones of the n fixed beds:
   a zone I of elution of the impurities, located between a point of injection of the eluent and a point of withdrawal of the extract;
   a zone II of elution of the polyolefins, located between the point of withdrawal of the extract and a point of injection of the polymer solution;
   a zone III of retention of the impurities, located between the point of injection of the polymer solution and a point of withdrawal of the raffinate; and
   optionally, and preferably, a zone IV, located between the point of withdrawal of the raffinate and the point of injection of the eluent,
wherein the points of injection and of withdrawal are shifted over time by one fixed bed of size exclusion solid according to a frequency determined by a predetermined permutation period,
wherein said raffinate is recovered in order to constitute at least part, preferably all, of the purified polymer solution;
c) a step of polymer-solvent separation of the purified polymer solution, in order to obtain at least one stream of purified polyolefins, in particular a stream of purified polypropylene, a stream of purified polyethylene, a stream of the copolymers thereof or a stream of a purified mixture of polypropylene and polyethylene, and at least one solvent fraction comprising dissolution solvent and possibly eluent.

### Feedstock

The feedstock of the process according to the invention, referred to as the “plastic feedstock”, comprises plastics which themselves in particular comprise polymers and more particularly polyolefins, such as polypropylene, polyethylene, copolymers thereof or mixtures thereof. Preferably, the plastic feedstock comprises between 50% and 100% by weight and with preference between 70% and 100% by weight of plastics.

The plastics included in the feedstock of the process according to the invention are generally production rejects and/or “post-consumer” waste, especially household waste, building waste, waste from the automotive sector or waste electrical and electronic equipment. Preferably, the plastic waste is obtained from collection and sorting channels. Plastics or plastics materials are generally compositions (or formulations) comprising polymers, in particular polyolefins, which are usually mixed with additives so as to give the materials specific properties, with a view to constituting, after forming, various objects (for example injection-moulded parts, tubes, films, fibres, fabrics, mastics, coatings, etc.). The additives used in plastics may be organic compounds or inorganic compounds. They are, for example, fillers, dyes, pigments, plasticizers, property modifiers, combustion retardants, etc.

The plastic feedstock of the process according to the invention thus comprises polymers and in particular polyolefins, such as polypropylene, polyethylene, copolymers thereof or mixtures thereof. With preference, the plastic feedstock comprises at least 50% by weight, preferably at least 80% by weight, preferably at least 85% by weight, with preference at least 90% by weight, of polyolefins relative to the total weight of the plastic feedstock, 100% advantageously being the maximum upper limit. The process according to the invention is thus most particularly directed towards purifying and recovering the polyolefins contained in the plastic feedstock in order to be able to reuse them in various applications.

The plastic feedstock may comprise other polymers other than the targeted polyolefins, and other impurities, in particular additives typically used to formulate the plastics material, and generally use-related impurities resulting from the life cycle of plastics materials and objects and/or resulting from the waste collection and sorting circuit. The plastic feedstock of the process according to the invention generally comprises less than 50% by weight of impurities, preferably less than 20% by weight of impurities, with preference less than 10% by weight of impurities. The plastic feedstock may comprise, for example, 1% by weight of impurities or more, in particular 5% by weight of impurities or more.

The plastic feedstock comprising polyolefins, treated by means of the process according to the invention, may advantageously be pretreated prior to the process according to the invention, so as to at least remove all or some of the “coarse” impurities, i.e. impurities in the form of particles greater than or equal to 10 mm, preferably greater than or equal to 5 mm, or even greater than or equal to 1 mm in size, for example impurities such as wood, paper, biomass, iron, aluminium, glass, etc., and to put it into form, generally into the form of divided solids, so as to facilitate the treatment in the process according to the invention. This pretreatment may comprise a grinding step, a step of washing at atmospheric pressure and/or a drying step. This pretreatment may be performed at a different site, for example in a waste collection and sorting centre, or at the same site where the purification process according to the invention is performed. Preferably, this pretreatment makes it possible to reduce the content of impurities to less than 6% by weight relative to the total weight of the plastic feedstock. At the end of the pretreatment, the plastic feedstock is generally stored in the form of divided solids, for example in the form of ground material, powder, flakes or granules, so as to facilitate the handling and transportation into the process.

### Dissolution Step a)

According to the invention, the process comprises a dissolution step a) in which the plastic feedstock is brought into contact with a dissolution solvent, in order to obtain at least one, preferably just one, crude polymer solution. Specifically, this step advantageously enables the dissolution of at least some and preferably of all of the targeted polymers, preferably of the targeted polyolefins, present in the plastic feedstock.

The term “dissolution” should be understood as meaning any phenomenon leading to the production of at least one polymer solution (in particular a polyolefin solution), i.e. a liquid (or possibly a supercritical fluid) comprising polymers (in particular polyolefins) dissolved in a solvent, more particularly in the dissolution solvent. A person skilled in the art is fully aware of the phenomenon/phenomena involved in the dissolution of polymers, the phenomenon/phenomena comprising at least mixing, dispersion, homogenization, solvation, disentangling of the polymer chains and more particularly of the thermoplastic chains.

In the course of and at the end of the dissolution step a), the pressure and temperature conditions make it possible to maintain the dissolution solvent, at least in part, and preferably all of the dissolution solvent, in the liquid or possibly supercritical state (the temperature and pressure conditions in step a) making it possible to avoid or at least to limit the presence of the dissolution solvent in gas form), while the soluble fraction of the feedstock, in particular the targeted polymers, most particularly the targeted polyolefins, and at least some of the impurities, is advantageously at least partly and preferably completely dissolved.

The dissolution solvent is an organic solvent or a mixture of organic solvents, preferably chosen so that its Hansen parameters are within the Hansen sphere of the targeted polymer, in particular of the targeted polyolefins. The Hansen theory makes it possible to predict the solubility of a polymer, in particular of a thermoplastic, such as polyolefins (polyethylene and/or polypropylene), in a solvent, by virtue of the determination of the Hansen solubility parameters and sphere for respectively the solvent and the polymer, as a function of several parameters, in particular of their polar, hydrogen bonding and dispersion parameters. If a solvent or mixture of solvents exhibits Hansen parameters in the Hansen sphere of the targeted polymer, said polymer should be at least partially, preferably entirely, soluble in said solvent. Advantageously, the dissolution solvent comprises, and preferably consists of, at least one hydrocarbon compound which is preferably aliphatic and in particular paraffinic (i.e. saturated), preferably linear or branched. Preferably, the dissolution solvent comprises at least 80% by weight, preferentially at least 95% by weight, with preference 98% by weight of at least one hydrocarbon compound which is preferably aliphatic and in particular paraffinic, preferably linear or branched, the percentages being expressed relative to the total weight of the dissolution solvent (100% being the maximum). Preferably, the dissolution solvent comprises at least one hydrocarbon compound which is preferably aliphatic and in particular paraffinic, having a boiling point (at atmospheric pressure, in particular at 0.1 MPa) of between-50 and 250° C., preferably between-15 and 150° C., preferentially between-1 and 110° C. and with preference between 2° and 100° C. With preference, the dissolution solvent comprises, preferably consists of, at least one hydrocarbon compound which is preferably aliphatic and in particular paraffinic, preferably linear or branched, containing between 3 and 12 carbon atoms, preferentially between 4 and 8 carbon atoms, for example 4, 5, 6, 7 or 8 carbon atoms. For example, the dissolution solvent comprises a hydrocarbon compound chosen from the isomers of butane, pentane, hexane, heptane and octane. The dissolution solvent may comprise, preferably consist of, a mixture of isomers of butane, pentane, hexane, heptane and/or octane, and with preference in a content of said mixture in the dissolution solvent being greater than or equal to 80% by weight, preferentially greater than or equal to 95% by weight, with preference greater than or equal to 98% by weight, relative to the total weight of the dissolution solvent. Very advantageously, a preferred hydrocarbon compound for the dissolution solvent is a paraffinic aliphatic compound, having a critical temperature (temperature at the critical point of said pure hydrocarbon compound) of preferably between 95 and 350° C., preferentially between 130 and 300° C., with preference between 18° and 285° C.

Preferably, the dissolution step a) is fed with the plastic feedstock and a dissolution solvent in a weight ratio between the dissolution solvent in relation to the plastic feedstock of between 0.2 and 100.0, preferably between 0.3 and 20.0, with preference between 1.0 and 10.0, even more preferentially between 3.0 and 7.0.

Advantageously, the dissolution solvent which feeds the dissolution step a) is in liquid or possibly supercritical form. Advantageously, it may be preheated, preferably to a temperature between 10° and 300° C., preferentially between 15° and 250° C., prior to its introduction into step a), in particular prior to its introduction into the contacting section and optionally into the dissolution section, so as to facilitate the heating of the plastic feedstock and/or avoid a temperature drop of the material stream in the contacting and optionally dissolution sections of step a).

Advantageously, the dissolution solvent comprises, and preferably consists of, fresh solvent (or a supply of fresh solvent) and/or a stream of recycled solvent obtained from a subsequent step of the process, for example at least partly obtained from the solvent-polymer separation step c).

Very advantageously, the dissolution step is performed at a temperature, known as the dissolution temperature, of between 100° C. and 300° C., preferably between 150° C. and 250° C., and a pressure, known as the dissolution pressure, of between 1.0 and 100.0 MPa absolute, preferably between 1.0 and 25.0 MPa absolute, preferentially between 1.5 and 18.0 MPa absolute and very preferably between 2.0 and 15.0 MPa absolute. The temperature and pressure may change during the dissolution step from the conditions of introduction of the plastic feedstock and/or dissolution solvent to the dissolution conditions, i.e. the dissolution temperature, in particular between 10° and 300° C., preferably between 15° and 250° C., and the dissolution pressure, in particular between 1.0 and 100.0 MPa absolute, preferably between 1.0 and 25.0 MPa absolute, preferentially between 1.5 and 18.0 MPa absolute and very preferably between 2.0 and 15.0 MPa absolute. Very advantageously, at the end of the dissolution step, the crude polymer solution is at the dissolution temperature and the dissolution pressure.

Limiting the temperature in the dissolution step a) to a temperature of less than or equal to 300° C., preferably less than or equal to 250° C., makes it possible to avoid or limit the thermal degradation of the polyolefins, but also to limit the energy requirement of the process, thus helping to limit the operating costs of the process. Advantageously, the dissolution temperature is greater than or equal to the melting point of the targeted polyolefins, so as to promote their dissolution and very advantageously to reduce the residence time required to effectively dissolve the targeted polyolefins. Very preferably, the temperature in the dissolution step a) is less than or equal to the critical temperature of the dissolution solvent, so as to avoid the formation of a supercritical phase during the dissolution step a) which is liable to disrupt the dissolution.

At the same time, the dissolution pressure in the dissolution step is higher than the saturation vapour pressure of the dissolution solvent at the dissolution temperature, so that the dissolution solvent is at least partly, and preferably completely, in liquid or possibly supercritical form at the dissolution temperature, which makes it possible to optimize the dissolution of the polyolefins, in particular especially in terms of quality and operation time.

Very advantageously, the dissolution temperature and pressure conditions reached in the dissolution step a) are adjusted so that the mixture (dissolution solvent+targeted thermoplastics) is single-phase at the end of step a), said mixture possibly comprising insoluble impurities suspended in said mixture.

Advantageously, said dissolution step a) is performed for a residence time preferably of between 1 and 600 minutes, preferably between 2 and 300 minutes, preferably between 2 and 180 minutes. The residence time is understood as being the residence time at the dissolution temperature and at the dissolution pressure, i.e. the time of processing of the plastic feedstock with the dissolution solvent at the dissolution temperature and at the dissolution pressure, in step a).

In order to enable the dissolution solvent and the plastic feedstock to be brought into contact with each other and, above all, to enable the targeted polyolefins to be dissolved efficiently and homogeneously in the dissolution solvent, the dissolution step may advantageously implement various types of equipment such as mixing, transporting and heating devices, for instance a reactor, a pump, a transport circuit, a stirring system, an oven, an exchanger, a mixer, etc. In particular, step a) advantageously implements at least one dissolution equipment, and optionally at least one feedstock preparation device, a mixing device and/or a transporting device. These equipment and/or devices may be, for example, one or more static mixers, an extruder, a pump, a reactor, a co-current or counter-current column, or a combination of lines and of equipment. Devices for transporting in particular fluids, such as gases, liquids or solids, are well known to those skilled in the art. In a non-limiting manner, the transporting devices may comprise a compressor, a pump, an extruder, a vibrating tube, an endless screw or a valve. The equipment and/or devices implemented in step a) may also comprise or be combined with heating systems (for example an oven, an exchanger, a heat tracing cable, etc.) to achieve the conditions required for dissolution.

The dissolution step a) is at least fed with the plastic feedstock, in particular in the form of one or more streams of plastic feedstock, and with the dissolution solvent, in particular in the form of one or more streams of dissolution solvent, advantageously by means of one or more transporting devices. The stream(s) of plastic feedstock may be distinct from the stream(s) of dissolution solvent. Some or all of the plastic feedstock may also feed step a) as a mixture with some or all of the dissolution solvent, the remainder of the solvent and/or of the feedstock, where appropriate, possibly feeding step a) separately.

During the bringing of the plastic feedstock into contact with the dissolution solvent, the dissolution solvent is advantageously at least partly, and preferably completely, in liquid or possibly supercritical form, whereas the plastic feedstock, which comprises polymers, in particular polyolefins, may be in solid or liquid form and optionally comprise solid particles in suspension. The plastic feedstock may also optionally be injected into the dissolution equipment, as a mixture with the dissolution solvent, in the form of a suspension in the dissolution solvent, the preparation and injection of the suspension possibly being continuous or batchwise.

Preferably, the dissolution step a) implements at least one extruder and a dissolution equipment, for example at least one Continuous Stirred Tank Reactor (CSTR), and at least one mechanical stirring system. In this case, the plastic feedstock feeds the extruder such that, at the extruder outlet, at least some and preferably all of the targeted polyolefins included in the plastic feedstock are in the molten state. The plastic feedstock is then injected at least partly in molten form into the dissolution equipment. The plastic feedstock, at least partly in the molten state, may also be pumped by means of a pump dedicated to viscous fluids, often known as a melt pump or a gear pump. The plastic feedstock at least partly in the molten state may, at the extruder outlet, also be filtered by means of a filtration device, optionally in addition to the melt pump, for the purpose of removing the coarsest particles; generally, the mesh size of this filter is between 10 μm (micrometres) and 1 mm (millimetre), preferably between 20 and 200 μm.

Preferably, step a) implements, prior to at least one CSTR-type reactor, at least one static mixer and an extruder into which at least a fraction of the dissolution solvent is injected, so as to promote shearing and intimate mixing between the dissolution solvent and the plastic feedstock, thus contributing towards the dissolution of the polyolefins.

Very advantageously, the crude polymer solution obtained at the end of the dissolution step a) comprises at least the dissolution solvent and targeted polyolefins dissolved in the dissolution solvent. In general, the crude polymer solution also comprises soluble impurities which are also dissolved in the dissolution solvent and optionally insoluble impurities in suspension. The crude polymer solution obtained at the end of the dissolution step a) may optionally also comprise polymers, other than the targeted polyolefins, for example in the molten state, dissolved state or undissolved state.

Optional Step b′) of Separation of the Insoluble Materials

The process according to the invention may optionally comprise a step b′) of separation of the insoluble materials from the crude polymer solution, in particular by solid-liquid separation, which is advantageously located upstream of step b) of extraction by size exclusion. Step b′) of separation of the insoluble materials thus makes it possible, when it is incorporated in the process according to the invention, to advantageously obtain a clarified polymer solution, which is a polymer solution from which, at least some, preferably all, of the insoluble impurities have been removed. Said step b′) of separation of the insoluble materials also makes it possible advantageously, when it is incorporated in the process according to the invention, to separate an insoluble fraction, which comprises at least some, and preferably all, of the insoluble impurities in particular in suspension in the crude polymer solution obtained from step a). The insoluble impurities removed during the optional step b′) of separation of the insoluble materials are, for example, additives originally present in the plastic feedstock (pigments, fillers, other polymers, etc.) and/or use-related impurities (such as mineral compounds, glass, wood, paper, metal, other polymers or degradation products). Preferably, step b′) also makes it possible to obtain a clarified polymer solution and an insoluble fraction.

Advantageously, the step b′) of separation of the insoluble materials, when it is carried out, is located upstream of step b) of extraction by size exclusion and typically downstream of the dissolution step a). When it is carried out, this separation step b′) advantageously makes it possible, besides the removal of at least some of the insoluble impurities, to limit the operating problems, in particular of clogging and/or erosion type, of the steps of the process located downstream, while contributing to the purification of the plastic feedstock. Preferably, the process according to the invention comprises a step b′) of separation of the insoluble materials.

Step b′) of separation of the insoluble materials is advantageously carried out under temperature and pressure conditions close to those of step a). Very advantageously, step b′) of separation of the insoluble materials is performed under the temperature and pressure conditions of the dissolution step a), i.e. at the dissolution temperature and dissolution pressure as defined above. Thus, very advantageously, step b′) is performed at a temperature of between 100° C. and 300° C., preferably between 15° and 250° C., and a pressure of between 1.0 and 100.0 MPa absolute, preferably between 1.0 and 25.0 MPa absolute, preferentially between 1.5 and 18.0 MPa absolute and very preferably between 2.0 and 15.0 MPa absolute

When it is incorporated in the process, step b′) of separation of the insoluble materials is preferably fed with the crude polymer solution obtained from step a).

Advantageously, the optional step b′) may implement a section comprising at least one solid-liquid separation equipment, for example a knockout drum, a decanter, a centrifugal decanter, a centrifuge, a filter, a sand filter, a tangential filter implementing in particular a membrane and/or a depth filter, optionally in the presence of filtration adjuvants (for example diatomaceous earths or sand), an eddy current separator, an electrostatic separator, a triboelectric separator, preferably a decanter, a filter, a sand filter and/or an electrostatic separator. Advantageously, a self-cleaning filter may be used, the cleaning or declogging making possible the removal of the insoluble materials being carried out in particular using a solvent stream.

The removal of the insoluble fraction may require the use of equipment making possible the transportation and optionally making possible the removal of solvent which may be entrained in the separated insoluble fraction. For example, step b′) may implement a conveyor, a vibrating tube, an endless screw, an extruder or a stripper. Step b′) may thus implement transportation equipment in order to discharge the insoluble fraction and/or to remove solvent possibly entrained with the separated insoluble fraction. Advantageously, at least a portion of the solvent possibly entrained with the separated insoluble fraction is recovered and recycled into the process.

According to a particular embodiment, step b′) of separation of the insoluble materials implements at least two, and generally less than five, solid-liquid separation equipment in series and/or in parallel. The presence of at least solid-liquid separation equipment in series makes it possible to improve the removal of the insoluble materials, while the presence of equipment in parallel makes it possible to manage the maintenance of said equipment and/or declogging operations.

Certain insoluble impurities, in particular certain pigments and mineral fillers, conventionally added during the formulation of polymers, may be introduced in the form of particles less than 1 μm in size. This is the case, for example, for titanium dioxide, calcium carbonate and carbon black. According to one embodiment, said step b′) of separation of the insoluble materials advantageously implements an electrostatic separator, which makes it possible to efficiently remove, at least in part, the insoluble particles less than 1 μm in size. According to another embodiment, step b′) of separation of the insoluble materials implements a sand filter, in order to remove the particles of different sizes and in particular particles less than 1 μm in size. According to yet another embodiment, step b′) of separation of the insoluble materials implements a tangential filter implementing in particular a membrane and/or a depth filter, optionally in the presence of filtration adjuvants, such as diatomaceous earths.

Depending on the nature of the plastic feedstock, the polymer solution which feeds step b′), preferably the crude polymer solution, may optionally also comprise a second liquid phase, for example consisting of molten polymers other than the targeted polyolefins. According to another particular embodiment, step b′) advantageously implements equipment making possible the separation of this second liquid phase, preferably by means of at least one three-phase separator.

In accordance with the invention, said optional step b′) of separation of the insoluble materials makes it possible, when it is incorporated in the process, to obtain at least one clarified polymer solution comprising at least the dissolution solvent and at least the targeted polyolefin(s) dissolved in said solvent. Thus, at least some, and preferably all, of the insoluble impurities potentially present in suspension in the crude polymer solution obtained at the end of step a) of the process according to the invention is removed from the polymer solution in step b′).

### Step (b) of Extraction by Size Exclusion

The process according to the invention comprises a step b) of extraction by size exclusion, which in particular is fed with an eluent and the crude polymer solution obtained from step a) or optionally with the clarified polymer solution obtained from step b′) of separation of the insoluble materials. Advantageously, step b) of extraction by size exclusion makes it possible to obtain at least one purified polymer solution and preferably a spent solvent, in particular laden with impurities.

The polymer solution which feeds step b) of extraction by size exclusion, in particular the crude polymer solution obtained from step a) or optionally the clarified polymer solution obtained from step b′) of separation of the insoluble materials, generally comprises dissolved impurities, which are advantageously removed, at least in part and preferably completely, during the extraction by size exclusion, in particular by bringing said crude or optionally clarified polymer solution into contact with a size exclusion solid in the presence of an eluent. Specifically, the step b) of extraction by size exclusion allows separation of the compounds present in the crude or optionally clarified polymer solution, in particular the separation of the dissolved polyolefins and the dissolved impurities, according to their size in particular on a molecular scale (or rather their hydrodynamic volume), by simulated counter-current chromatography or simulated mobile bed, referred to hereinbelow as the “SMB” process. Very advantageously, this extraction step b) of the process allows the selective separation of the polyolefins dissolved in the dissolution solvent from the dissolved impurities present in the polymer solution which feeds said step b) (i.e. the crude or optionally clarified polymer solution). Step b) thus makes it possible to produce a purified polymer solution, said purified polymer solution being a polymer solution freed of at least some, preferably all, of the soluble impurities present in the polymer solution which feeds said step b), that is to say present in the crude or optionally clarified polymer solution.

Preferably, the eluent which feeds step b) is a solvent, in particular an organic solvent, preferably one such that its Hansen parameters are within the Hansen sphere of the targeted polymers. Preferably, the eluent is a solvent, preferably an organic solvent, or mixture of solvents, preferably mixture of organic solvents, comprising at least 80% by weight, preferentially at least 95% by weight, with preference 98% by weight of a hydrocarbon compound, preferably an aliphatic and in particular paraffinic, preferably linear or branched hydrocarbon compound, the percentages being expressed relative to the total weight of the eluent (100% being the maximum), preferably having a boiling point (at atmospheric pressure) of between-50 and 250° C., preferably between-15 and 150° C., preferentially between-1 and 110° C. and with preference between 2° and 100° C. With preference, the eluent comprises, and preferably consists of, a hydrocarbon compound, preferably an aliphatic and in particular paraffinic, preferably linear or branched hydrocarbon compound, containing between 3 and 12 carbon atoms, preferentially between 4 and 8 carbon atoms, for example 4, 5, 6, 7 or 8 carbon atoms. For example, the dissolution solvent comprises a hydrocarbon compound chosen from the isomers of butane, pentane, hexane, heptane and octane. Very preferably, the eluent is of the same chemical nature, indeed even the same solvent, as the dissolution solvent.

Advantageously, step b) of extraction by size exclusion implements at least one train, preferably a single train, of several fixed beds of a size exclusion solid, in particular in operation. Said train(s) is (are) advantageously fed with the crude polymer solution obtained from step a) or optionally the clarified polymer solution obtained from the optional step b′), and with the eluent. When step b) comprises several, in particular between two and four, trains of fixed beds of size exclusion solid, in operation, these trains of fixed beds operate parallel to one another and are each fed with a fraction of the polymer solution which feeds step b), in particular the crude polymer solution obtained from step a) or optionally the clarified polymer solution obtained from the optional step b′), and with a fraction of the eluent which feeds step b). In this case, said polymer solution which feeds step b) is then divided into as many partial streams of crude or optionally clarified polymer solution as there are trains of fixed beds in operation, and similarly said eluent which feeds step b) is then divided into as many partial streams of eluent as there are trains of fixed beds in operation.

Optionally, the process may also comprise, in particular parallel to step b), at least one train of fixed beds of size exclusion solid (as described below), which is (are) not in operation, in particular which are at standstill on standby and/or in regeneration and/or backup mode.

The (or each) train of fixed beds, advantageously in operation, of step b) of extraction by size exclusion comprises n fixed beds of a size exclusion solid, n being an integer greater than or equal to 4, preferably of between 4 and 30, preferentially between 8 and 24, very preferentially between 8 and 21 and with preference between 12 and 15. The number of fixed beds must be sufficient, in order to make possible efficient separation, and reasonable, so as to limit the costs, in particular the capital costs. The n fixed beds are in series with respect to one another. The n fixed beds of size exclusion solid may operate in a closed loop or in an open circuit. Preferably, the n fixed beds of size exclusion solid operate in a closed loop, that is to say that the n fixed beds are connected to one another successively and preferably in a closed loop (the first is connected to the second, the second to the third, and the like, and the n^{th} to the first), thus making possible continuous operation of the extraction by size exclusion and advantageously a reduction in the consumption of eluent, since the eluent is then in part continuously regenerated and recycled.

In one (or each) train of fixed beds, the n fixed beds of size exclusion solid are advantageously distributed in one or more columns, preferably in M column(s), M being an integer of between 1 and the total number of fixed beds of exclusion solid of the train under consideration, that is to say M being between 1 and n. Thus, the (or each) train of fixed beds of step b) of extraction by size exclusion may implement between 1 and n column(s), each comprising one or more fixed beds of size exclusion solid. For example, the (or each) train of fixed beds of step b) of extraction by size exclusion may implement a single column (or tower), preferably of large capacity (volume), which comprises the n fixed beds, or two columns, each of which comprises n/2 fixed beds. These two configurations make it possible to significantly limit the capital costs but require unloading the entire column, i.e. n fixed beds or n/2 fixed beds, when there is a problem with regard to one of the beds of the column. According to another embodiment, the (or each) train of fixed beds of step b) of extraction by size exclusion implements n columns (or towers), preferably each of the columns being of smaller capacity (volume) than in the preceding case, each of the columns comprising a fixed bed of size exclusion solid, thus facilitating the maintenance and/or the cleaning and/or the by-passing in particular of one bed among the n beds in operation since, in this configuration, just one column (which comprises just one bed) has to be unloaded and/or by-passed rather than an assembly of beds. However, the latter configuration entails significant capital costs.

Preferably, the size exclusion solid is provided in the form of solid particles. It may also be referred to as a granular medium. The size exclusion solid is chosen so as to be inert with respect to the polymer solution to be treated, i.e. the dissolution solvent and the polyolefins to be treated, and with respect to the eluent. It is also chosen so as to enable efficient separation of the compounds present, in particular dissolved, in the treated polymer solution, and more particularly efficient separation of the impurities dissolved in the dissolution solvent relative to the dissolved polyolefins. The size exclusion solid is advantageously a porous solid which may be organic (generally polymeric) and/or inorganic, and preferably having a volume-average pore diameter of preferably between 1 nm and 500 nm, preferentially between 2 nm and 100 nm, very preferentially between 2 nm and 50 nm, and with preference between 3 nm and 30 nm. Advantageously, the size exclusion solid comprises silica (such as a silica gel, also referred to as silica, and/or grafted silica), a carbon molecular sieve, a polymeric molecular sieve (other than polyolefinic in chemical nature), a porous polymer gel, a carbon replica, a preferably dealuminated zeolite (for example of USY type), a preferably calcined alumina, a material of MOF (metal organic framework) type or mixtures thereof. Preferably, the size exclusion solid comprises, preferably consists of, a silica gel (or silica), a grafted silica, a carbon molecular sieve or mixtures thereof. Very advantageously, the size exclusion solid preferably has a pore volume of between 0.01 and 3.0 ml/g, preferably between 0.1 and 2.0 ml/g, preferentially between 0.3 and 1.2 ml/g. The average pore diameter and the pore volume of the size exclusion solid are determined by mercury porosimetry and more particularly measured by mercury intrusion porosimetry according to Standard ASTM D4284-83 at a maximum pressure of 4000 bar, using a surface tension of 484 dynes/cm and a contact angle of 140°. The wetting angle which was taken is equal to 140° following the recommendations of the publication “Techniques de l'ingénieur, traité analyse et caractérisation” [Engineering Techniques, Analysis and Characterization Treatise], page 1050, by J. Charpin and B. Rasneur. In order to obtain better preciseness, the given value of the mercury volume in ml/g corresponds to the value of the total mercury volume in ml/g measured on the sample minus the value of the mercury volume in ml/g measured on the same sample for a pressure corresponding to 30 psi (approximately 2 bar). These same parameters, and in particular the volumes and diameter of the solid in the mesoporosity range (2-50 nm), may also be measured by nitrogen adsorption/desorption volumetry (also called nitrogen adsorption isotherm), an analysis method complementary to that mentioned above. This analysis corresponds to the physical adsorption of nitrogen molecules in the porosity of the material via a gradual increase in pressure at constant temperature and provides information on the textural characteristics. In particular, it makes it possible to access the mesoporous distribution of the size exclusion solid. Thus, the pore distribution representative of a population of pores centred in a range from 2 to 50 nm is determined by the Barrett-Joyner-Halenda (BJH) model. The nitrogen adsorption-desorption isotherm according to the BJH model is described in the periodical “The Journal of the American Chemical Society”, 73, 373 (1951), written by E. P. Barrett, L. G. Joyner and P. P. Halenda.

The particles of size exclusion solid preferably have a volume-average equivalent diameter (preferably determined by laser particle size analysis, that is to say by laser diffraction using a particle size analyzer) of between 20 and 5000 μm, preferably between 50 and 1500 μm, preferentially between 100 and 800 μm and more preferably still between 300 and 600 μm. Advantageously, the solid particles are substantially spherical.

According to the invention, the (or each) train of fixed beds of step b) of extraction by size exclusion is fed with crude or optionally clarified polymer solution at at least one point of injection F of the polymer solution and with at least one eluent at a point of injection S of the eluent. Preferably, the train of fixed beds under consideration is fed with crude or optionally clarified polymer solution at a point of injection F of the polymer solution and with an eluent at a point of injection S of the eluent.

Preferably, the eluent and the polymer solution feed the (or each) train of fixed beds of step b) of extraction by size exclusion according to a ratio of the flow rates by volume of the eluent in relation to the polymer solution of between 0.1 and 50.0, preferably between 0.2 and 10.0, preferably between 0.5 and 5.0, preferentially between 0.8 and 2.0, it also being possible to refer to such a ratio as level of solvent. Such a level of solvent, that is to say such an adjustment of the flow rate by volume of the crude or optionally clarified polymer solution and of the flow rate by volume of the eluent, for the (or each) train under consideration, contributes to the efficiency of the separation by size exclusion of the polyolefins and of the impurities present in the polymer solution which feeds step b).

When the train of fixed beds comprises several points of injection Fi of the polymer solution, for example two points of injection F1 and F2 of the polymer solution, the stream of the crude or clarified polymer solution which feeds said considered train of fixed beds is divided into as many partial streams of polymer solution for feeding said train of fixed beds at said injection points Fi, said partial streams of polymer solution exhibiting flow rates which are identical to or different from one another.

When the train of fixed beds comprises several points of injection Si of eluent, for example two injection points S1 and S2, the total stream of eluent which feeds said considered train of fixed beds is divided into as many partial streams of eluent (that is to say, into i partial streams of eluent, i being an integer equal to the number of points of injection Si of eluent) for feeding said train of fixed beds at said injection points Si, said partial streams of eluent exhibiting flow rates which are identical to or different from one another.

The (or each) train of fixed beds of step b) of extraction by size exclusion implements at least one withdrawal of an extract at at least one point of withdrawal E of the extract, and at least one withdrawal of a raffinate at at least one point of withdrawal R of the raffinate. Preferably, the (or each) train of fixed beds of step b) of extraction by size exclusion implements a withdrawal of an extract at a point of withdrawal E of the extract, and a withdrawal of a raffinate at a point of withdrawal R of the raffinate.

The points of injection F of the polymer solution and S of the eluent and the points of withdrawal E of the extract and R of the raffinate are distinct from one another. They are advantageously located between two consecutive beds, or optionally upstream of the first bed, in particular in the case of an open circuit (in the case of a closed loop of n fixed beds, as the n^{th} bed is connected to the first bed, these two beds are considered as consecutive). However, they may be located, in the case of an embodiment notably according to a VARICOL® process, on average over an operating cycle, in the middle of a fixed bed or in a fixed bed. The points of injection of the polymer solution and of the eluent and the points of withdrawal of the extract and of the raffinate are distributed with respect to one another so that they determine at least three, preferably four, successive main operating zones of the n fixed beds:
a zone I of elution of the impurities, comprised between the point of injection S of the eluent and the point of withdrawal E of the extract;
a zone II of elution of the polymer (in particular of the targeted polyolefins), comprised between the point of withdrawal E of the extract and the point of injection F of the polymer solution;
a zone III of retention of the impurities, comprised between the point of injection F of the polymer solution and the point of withdrawal R of the raffinate; and
optionally, and preferably, a zone IV comprised between the point of withdrawal R of the raffinate and the point of injection S of the eluent.

When there exist several points of injection Fi of the polymer solution and/or Si of the eluent and/or several points of withdrawal of the extract and/or of the raffinate, the zones I, II, III and optionally IV start at the first point of injection and/or of withdrawal of the stream under consideration (eluent, polymer solution, extract or raffinate), the term “first” being defined here as being that which is the furthest upstream of all of the points of injection and/or of withdrawal of said stream under consideration. When there exist several points of injection Fi of the polymer solution and/or Si of the eluent and/or several points of withdrawal of the extract and/or of the raffinate, secondary operating zones may also be defined, in particular inside the zones I, II, III and optionally IV which are the main operating zones.

When the n fixed beds of the train under consideration of step b) operate in an open circuit, the eluent is introduced at the point(s) of injection S of the eluent, the crude or optionally clarified polymer solution is introduced at the point(s) of injection F of the polymer solution, the extract is withdrawn at the point(s) of withdrawal E of the extract and all the remainder is withdrawn at the point(s) of withdrawal R of the raffinate. The injection and withdrawal points thus define three successive main operating zones, zones I, II, III. In this embodiment, a large amount of eluent, with respect to the polymer solution, is generally necessary in order to be able to maximize the separation. For example, this mode of operation in an open circuit requires a ratio of the flow rates by volume of the eluent in relation to the polymer solution of between 2.0 and 50.0, preferably between 5.0 and 20.0, indeed even between 5.0 and 10.0.

When the n fixed beds of the train under consideration of step b) operate in a closed loop, the eluent is introduced at the point(s) of injection S of the eluent, the crude or optionally clarified polymer solution is introduced at the point(s) of injection F of the polymer solution, an extract is withdrawn at the point(s) of withdrawal E of the extract, a raffinate is withdrawn at the point(s) of withdrawal R of the raffinate and at least some of the eluent introduced advantageously remains in circulation in the closed loop of the n beds (the expression used is then recycling of the eluent). In this embodiment, the points of injection and of withdrawal then define four successive main operating zones, zones I, II, III and IV, it being possible for zone IV to be called the zone for regeneration and recycling of the eluent. In this particular embodiment, the eluent supply requirements (i.e. the amounts of eluent introduced at S) are very advantageously smaller than in the case of an operating mode of an open circuit for ensuring efficient separation. For example, this mode of operation in a closed loop requires a ratio of the flow rates by volume of the eluent in relation to the polymer solution of between 0.1 and 10, preferably between 0.2 and 5.0, indeed even between 0.8 and 2.0.

Advantageously, in the case of a closed loop of the n fixed beds, the n beds of size exclusion solid are distributed in the zones I to IV, preferably according to a configuration of a/b/c/d type, the distribution of the beds of size exclusion solid in the zones I to IV, with respect to the total number n of beds of size exclusion solid, being such that:
a is the number of beds of size exclusion solid in zone I,
b is the number of beds of size exclusion solid in zone II,
c is the number of beds of size exclusion solid in zone III, and
d is the number of beds of size exclusion solid in zone IV, and wherein:

$$a = ( n * 0.3 ) * ( 1 \pm 0.4 , preferably 1 \pm 0.3 ) ,$$

$$b = ( n * 0.15 ) * ( 1 \pm 0.4 , preferably 1 \pm 0.3 ) ,$$

$$c = ( n * 0.25 ) * ( 1 \pm 0.4 , preferably 1 \pm 0.3 ) , and$$

$$d = ( n * 0.3 ) * ( 1 \pm 0.4 , preferably 1 \pm 0.3 ) .$$

It is obvious to a person skilled in the art that the sum of the number of fixed beds in the zones I, II, III and IV (i.e. a+b+c+d) is advantageously equal to n, the total number of fixed beds in the considered train of fixed beds in operation. Thus, a 6/3/4/2 configuration means that there are 15 fixed beds of size exclusion solid divided into 6 fixed beds in zone 1, 3 fixed beds in zone II, 4 fixed beds in zone III and 2 beds in zone IV.

Very advantageously, the packing density of each of the n fixed beds of size exclusion solid, expressed by mass of size exclusion solid per unit volume of bed (i.e., by kg of solid per m³ of bed) may vary between 100 and 1500 kg/m³, preferably between 300 and 1000 kg/m³, preferentially between 400 and 800 kg/m³.

According to the invention, the points of injection F and S and of withdrawal E and R are shifted over time by one bed of size exclusion solid, according to a frequency determined by a predetermined permutation period. A permutation period may be defined as being the period of time between two successive displacements (or shiftings) by one fixed bed of the injection and withdrawal points. The periodic displacement (or shifting) of the points of injection F and S and of withdrawal E and R may be carried out synchronously or non-synchronously, the latter case (non-synchronously) possibly being known under the name of VARICOL®. The periodic displacement of the points of injection and of withdrawal along the entire length of the n fixed beds makes it possible in particular to define an operating cycle and also advantageously a cycle time which corresponds to the period of time required for the points of injection and of withdrawal to return to their initial position, that is to say corresponds to the number of beds n multiplied by the permutation period.

When the n fixed beds of exclusion solid operate in a closed loop, an operating cycle thus advantageously comprises as many permutation periods as beds of size exclusion solid present in the closed separation loop. For example, an operating cycle of a train comprising 12 fixed beds of size exclusion solid comprises 12 permutation periods. Thus, in the preferred embodiment in which the n fixed beds of exclusion solid of the considered train of fixed beds operate in a closed loop, the permutation period is preferably adjusted so as to define a cycle time, which corresponds to the period of time required for the points of injection and of withdrawal to return to their initial position, of between 1 minute and 600 minutes, preferably between 5 minutes and 200 minutes, with preference between 10 minutes and 90 minutes. Such a cycle time contributes towards the efficiency of the separation by size exclusion of the polyolefins and of the impurities present in the polymer solution which feeds step b).

In the case of the embodiment in which the n fixed beds operate in an open circuit (that is to say that everything is withdrawn with the extract and the raffinate), the cycle time may also be between 1 minute and 600 minutes, preferably between 5 minutes and 200 minutes, with preference between 10 minutes and 90 minutes.

The displacement of the points of injection F and S and of withdrawal E and R may take place by the installation of a series of on-off valves, controlled by an automatic sequence, or also of a single rotary valve.

In general, the liquid flow in the fixed beds is advantageously from the bed i to the bed i+1, i being an integer of between 1 and n, the total number of fixed beds, that is to say from upstream to downstream, and being possibly referred to as downward liquid flow, even if the presence of pump(s) is necessary (in particular between the n^{th} bed and the first bed in the case of operation in a closed loop and where the n beds are in a column). At the moment of the permutation (or displacement of the injection and withdrawal points), the injection and withdrawal points are displaced by one bed, placed downstream of the preceding bed, thus creating/simulating a countercurrent liquid flow, optionally referred to as upward liquid flow. A stop flow rate may then be defined when the two countercurrent liquid flow rates are equal, that is to say when the downward liquid flow rate is equal to the upward liquid flow rate. This stop flow rate may be calculated by dividing the intergranular volume of the size exclusion solid in the beds by the permutation period, the intergranular volume of the size exclusion solid in the beds being a function of the packing density of the fixed beds of size exclusion solid and of the density of the particles of size exclusion solid. More particularly, the intergranular volume (V_{(intergranular)}) of the size exclusion solid may be calculated by the following formula:

$${V}_{( intergranular )} = {V}_{( beds )} \times ( 1 - {d}_{( packing )} / {d}_{( grain )} ) + {V}_{dead}$$

with:
V_{(intergranular)}: the intergranular volume of the size exclusion solid in the beds (in m³);
V_{(beds)}: the geometric volume of the beds (in m³);
d_{(packing)}: the packing density of the size exclusion solid in the beds (in kg/m³), corresponding to the true packing density of the size exclusion solid, that is to say to the mass of said solid per unit volume of the bed. As a first approach, it may be likened to the tapped packing density, which consists of the mass of solid which occupies a given volume after tapping said solid by vibration, according to a principle derived from Standards D4164 and D4180 applied to the case of catalysts;
d_{(grain)}: the grain density of the size exclusion solid, typically measured by mercury porosimetry (in kg/m³);
V_{dead}: the volume (in m³) of the equipment without size exclusion solid but through which the fluid concerned flows, in particular the polymer solution (for example, the volume of the lines upstream, downstream, and the like).

The stop flow rate, which is a flow rate by volume, makes it possible to calculate dimensionless parameters, in particular relating to the zones II and IV, in particular the ratio of the flow rate by volume in the zone II to the stop flow rate, and the ratio of the flow rate by volume in the zone IV to the stop flow rate. Preferably, the ratio of the flow rate by volume of the zone IV divided by the stop flow rate is less than or equal to 2, preferentially of between 0.5 and 1.5 and more preferably still between 0.8 and 1.0. Preferably, the ratio of the flow rate by volume of the zone II divided by the stop flow rate is between 0.5 and 3.0, preferentially between 0.9 and 1.5 and preferably between 1.0 and 1.25. Thus, the stop flow rate makes it possible to contribute to the adjustments of the extraction step and thus to the efficiency of the separation.

Moreover, very advantageously, the superficial velocity in the fixed beds of an operating zone, which corresponds to the flow rate by volume in the zone considered divided by the cross section of said zone (i.e., of the column in which the beds of said zone considered are located) may be adjusted so that this superficial velocity is of between 0.01 and 10.0 cm/s and preferentially between 0.05 and 2.5 cm/s. The adjustment of the superficial velocity in the fixed beds advantageously makes it possible in particular to control the attrition of the particles of size exclusion solid and thus to adjust the operation of the train of fixed beds of step b) so as to avoid large pressure drops (in particular encountered at high velocity) and/or dispersion problems (in particular encountered at low velocity).

Preferably, step b) of extraction by size exclusion is performed at a temperature of between 100 and 300° C., preferably between 150° C. and 250° C., and at a pressure of between 1.0 and 100.0 MPa absolute, preferably between 1.0 and 25.0 MPa absolute, preferentially between 1.5 and 18.0 MPa absolute and very preferably between 2.0 and 15.0 MPa absolute. Under these operating conditions, the polyolefins remain dissolved in the dissolution solvent and optionally in the eluent, the latter (i.e. the dissolution solvent and the eluent) being for their part at least partly in liquid form. Preferably, the temperature and pressure conditions of step b) are the same as those of the dissolution step a).

Step b) of extraction by size exclusion thus makes it possible to recover at least one extract which comprises, at least in part, preferably completely, the impurities present in the polymer solution which feeds said step b) and at least one raffinate which comprises a polymer solution freed, at least in part, preferably completely, of impurities. Said raffinate recovered at the end of step b) of extraction by size exclusion in part or completely constitutes the purified polymer solution, which is recovered at the end of step b). This purified polymer solution is subsequently preferably sent, at least in part, preferably completely, to step c) of polymer-solvent separation. However, if necessary, it may be sent to at least one additional purification step, so as to optimize the purification of the targeted polyolefins, if need be. This step b) of extraction by size exclusion thus makes it possible to efficiently and continuously separate the, in particular soluble, impurities from the crude or optionally clarified polymer solution, comprising the polyolefins dissolved in the dissolution solvent.

The extraction by size exclusion, in particular in the case of a closed loop of fixed beds, makes it possible to efficiently separate the impurities from the polyolefins, in a continuous mode, which makes it possible to limit the labour required to perform said step while at the same time facilitating its operability. It also allows high productivity, in particular compared with size exclusion chromatography operations in batch mode, while providing a relatively low consumption of eluent.

### Step c) of Polymer-Solvent Separation

According to the invention, the process comprises a step c) of polymer-solvent separation of the purified polymer solution, in order to obtain at least one stream of purified polyolefins, in particular a stream of purified polypropylene, a stream of purified polyethylene, or a stream of the copolymers thereof, a stream of a purified mixture of polypropylene and polyethylene, and at least one solvent fraction comprising the dissolution solvent.

Step c) of polymer-solvent separation advantageously implements at least one solvent recovery section and preferably between one and five solvent recovery section(s).

Advantageously, step c) is fed with the purified polymer solution obtained at the end of step b) or optionally a final purified polymer solution obtained from an additional purification step located downstream of step b) of extraction by size exclusion.

Step c) of polymer-solvent separation is thus primarily targeted at separating, at least in part, preferably predominantly, the dissolution solvent and optionally the eluent from the targeted polyolefin(s) contained in the polymer solution which feeds step c), more particularly the purified polymer solution or optionally a final purified polymer solution obtained from an additional purification step, so as to recover at least the polyolefins, freed at least in part, preferably predominantly and preferentially completely, of the dissolution solvent, and optionally of the eluent, which are still present in the polymer solution which feeds step c). The term “predominantly” should be understood as meaning at least 50% by weight, preferentially at least 70% by weight, more preferably at least 90% by weight and more preferably still at least 95% by weight, relative to the weight of the solvent(s) contained in the purified polymer solution which feeds step c), in particular the dissolution solvent and optionally the eluent contained in said purified polymer solution. Any method of solvent(s)/polymer(s) separation known to a person skilled in the art may be carried out, in particular any method making possible a change in phase of the polymer(s) and/or solvent(s). The solvent(s) may be separated, for example, by precipitation or crystallization of the polymers, flash evaporation of the solvents, atomization, stripping, demixing, a difference in density and in particular decantation or centrifugation, etc.

Said at least one stream of purified polyolefins thus obtained may correspond to a polymer solution concentrated in polyolefins or to polyolefins in liquid (or viscous) or solid form. Preferably, step c) of polymer-solvent separation additionally comprises a conditioning section for conditioning the purified polyolefins in solid form and more particularly in the form of granules.

Step c) of polymer-solvent separation is also targeted at recovering, at least in part, preferably predominantly and preferentially completely, the solvent(s) contained in the purified polymer solution which feeds step c), in particular the dissolution solvent and optionally the eluent. Step c) of polymer-solvent separation is also optionally targeted at purifying and recycling the recovered solvent fraction, in particular upstream of the dissolution step a). The term “predominantly” should be understood as meaning at least 50% by weight, preferentially at least 70% by weight, more preferably at least 90% by weight and more preferably still at least 95% by weight, relative to the weight of the solvent(s) contained in the purified polymer solution which feeds step c).

Advantageously, step c) of polymer-solvent separation implements at least one solvent recovery section, the latter preferably comprising equipment operated at different temperatures and different pressures, for the purpose of obtaining at least one solvent fraction and one purified polymer fraction.

Thus, the process according to the invention makes it possible to efficiently and continuously recover the polyolefins from a plastic feedstock, with a high productivity and a limited number of operations. Very advantageously, the process according to the invention makes it possible to obtain a stream of polyolefins exhibiting a high purity, preferably of greater than or equal to 95%, preferably of greater than or equal to 99%, preferentially of greater than or equal to 99.5% (by weight of polyolefins, relative to the total weight of the purified stream recovered), starting from any type of plastic feedstock. Another advantage of the process according to the invention also lies in the fact that an efficient separation of the impurities, in particular of the additives, present in the plastic feedstock is possible, while making possible a reasonable consumption of solvents, in particular of dissolution solvent and of eluent, and a lower energy consumption than that required for more conventional “thermal” separations, such as crystallization. The process according to the invention thus makes it possible to obtain a stream of purified polyolefins which is less coloured than the plastic feedstock be treated, indeed even colourless, and very advantageously deodourized. The stream of purified polymers obtained preferably has negligible contents of substances prohibited or regulated, for example by the REACH Regulation. More particularly, the process according to the invention makes it possible to obtain a stream of purified polyolefins that is freed of at least some, preferably all, of the impurities, such as the additives, present in the plastic feedstock and freed, at least in part, indeed even completely, of solvent, in particular of the dissolution solvent and of the eluent.

Thus, the process according to the invention advantageously makes it possible to obtain a stream of purified polyolefins comprising a content of impurities of less than or equal to 5% by weight, preferably less than or equal to 1% by weight and more preferably still less than or equal to 0.5% by weight of impurities, and very advantageously a content of solvent (in particular of dissolution solvent and eluent) of less than or equal to 5% by weight of solvent, preferably less than or equal to 1% by weight, and with preference less than or equal to 0.1% by weight, the percentages being given relative to the total weight of the stream of purified polyolefins.

### Device for Extraction by Size Exclusion

The present invention also relates to a device for extraction by size exclusion suitable for separating polyolefins from impurities comprised in a polymer solution. Said device comprises:
n fixed beds of a size exclusion solid, n being an integer greater than or equal to 4, preferably of between 4 and 30, preferentially between 8 and 24, very preferentially between 8 and 21 and with preference between 12 and 15, said size exclusion solid having a volume-average pore diameter of preferably between 1 nm and 500 nm, preferably between 2 nm and 100 nm, preferentially between 2 nm and 50 nm, preferentially between 3 and 30 nm, and with preference being a silica gel (or silica), a grafted silica, a carbon molecular sieve or mixtures thereof,
the n fixed beds of the size exclusion solid being distributed in one or more column(s), preferably in M column(s), M being an integer of between 1 and the total number n of fixed beds of the exclusion solid, the n beds being connected in series and preferably in a closed loop,
N systems of injection, preferably distinct from one another, for the polymer solution, N systems of injection, preferably distinct from one another, for an eluent, N systems of withdrawal, preferably distinct from one another, for an extract and N systems of withdrawal, preferably distinct from one another, for a raffinate, N being an integer preferably equal to n, said injection and withdrawal systems being located between two consecutive beds or optionally upstream of the first bed,
wherein the systems for injection of the polymer solution and of the eluent and/or the systems for withdrawal of the extract and of the raffinate which are located at one and the same position, that is to say between the same two consecutive beds or optionally upstream of the first bed, are distinct or identical (the term “identical” should be understood as meaning that a system of valves can make possible either the introduction of the polymer solution or that of the eluent, or the withdrawal of one or the other stream, i.e. of the extract or of the raffinate),
each injection and withdrawal system comprising at least one valve suitable for allowing or not allowing the passage of a stream of polymer solution and/or of eluent and/or of extract and/or of raffinate, preferably i) a series of on-off valves which are controlled by an automatic sequence, or ii) a single rotary valve, so as:
to define, at an instant t, a point of injection of the polymer solution, a point of injection of the eluent, a point of withdrawal of the extract and a point of withdrawal of the raffinate, said points of injection and of withdrawal being distinct from one another and determining at least three, preferably four, successive main operating zones of the n fixed beds:
   a zone I of elution of the impurities, comprised between a point of injection of the eluent and a point of withdrawal of the extract;
a zone II of elution of the polyolefins, comprised between the point of withdrawal of the extract and a point of injection of the polymer solution;
a zone III of retention of the impurities, comprised between the point of injection of the polymer solution and a point of withdrawal of the raffinate; and
optionally a zone IV, comprised between the point of withdrawal of the raffinate and the point of injection of the eluent;

and to make possible, over time, a shifting in the points of injection and of withdrawal, synchronously or non-synchronously, according to a frequency determined by a predetermined permutation period, by one fixed bed of size exclusion solid per permutation period.

### Device for Treatment of a Plastic Feedstock

Such a device for extraction by size exclusion may be incorporated in a more encompassing device for treatment of a plastic feedstock in order to obtain a stream of purified polyolefins, which comprises:
dissolution means for bringing the plastic feedstock and a dissolution solvent into contact, so as to dissolve at least in part said plastic feedstock in said dissolution solvent, said dissolution means being any type of equipment for bringing the plastic feedstock into contact with a dissolution solvent and dissolving it, such as an extruder, one or more static mixers, one or more continuous stirred tank reactors (CSTR) equipped with suitable stirring system(s), in order to obtain a crude polymer solution;
optionally solid-liquid separation means, in particular optionally any type of equipment for solid-liquid separation, suitable for separating insoluble materials in suspension in the crude polymer solution;
at least one device for extraction by size exclusion according to the invention and as described above, advantageously connected to said dissolution means for bringing into contact and dissolving or optionally to at least one of said solid-liquid separation means;
means for separation of the dissolution solvent and optionally of the eluent from a stream of purified polyolefins, in particular optionally any type of equipment for separating the dissolution solvent and optionally the eluent from a stream of purified polyolefins, which are advantageously connected to said at least one device for extraction by size exclusion.

Said device for treatment of a plastic feedstock in order to obtain a stream of purified polyolefins also advantageously comprises means for transportation between said means and devices.

Such a device very advantageously makes it possible to recover the polyolefins with a high purity from a plastic feedstock which may comprise a multitude of impurities.

The example which follows and the figures illustrate the invention, in particular particular embodiments of the invention, without limiting the scope thereof.

### EXAMPLES

### Example 1

This example is the result of digital simulations carried out on the basis of experiments performed in the laboratory.

The feedstock to be treated is composed of 95% by weight of polyethylene (PE) with a volume-average molar mass MW=650 000 g/mol and 5% by weight of an additive, Irgafos® 168, which is conventionally used as a stabilizer in polyolefin formulations.

The feedstock is first dissolved in heptane at 200° C. and 1.0 MPa (or 10 bar), in order to form a homogeneous crude polymer solution comprising 80% by weight of heptane and 20% by weight of feedstock comprising the polyethylene and the additive.

The crude polymer solution formed is introduced into a simulated moving bed, composed of 15 beds comprising silica gel and distributed in a 6/3/4/2 configuration (see FIG. 1). The eluent is heptane.

The silica gel in the beds is in the form of beads and has the following characteristics:

$$Bead diameter = 500 μ m$$

$$Pore diameter = 6 - 10 nm$$

$$Pore volume = 0.8 ml / g$$

$$Packing density = 530 kg of solids / {m}^{3} of bed$$

$$Extragranular porosity = 0.4 .$$

Each bed is modelled by a 1D piston fixed bed model with axial dispersion and a Fick model for intragranular transfer. The radius of gyration of the polyethylene is estimated to be 32 nm, so the polymer is considered to be present only in the extragranular phase. The additive and the solvent have a radius of gyration of less than 1 nm and can thus diffuse into the intragranular porosity. The medium in the beds is considered isothermal (200° C.) and the density of the polymer solution is considered constant (477 kg/m³). Finally, all the beds are modelled and the cycles are solved dynamically until the concentration profile converges.

The extraction is adjusted with the following settings:

$$Cycle time = 15 min$$

Flow rate by volume of eluent (heptane) in relation to the flow rate by volume of polymer solution S/F=1.08;

$$Zone IV flow rate / stop flow rate = 0.92$$

$$Zone II flow rate / stop flow rate = 1.1$$

$$Maximum superficial velocity = 1.8 cm / s .$$

The concentration profiles obtained for the PE and the additive, by simulation, along the entire length of the simulated moving bed, with by convention an injection of the eluent upstream of bed 1 (and downstream of bed 15), is shown in FIG. 3. In FIG. 3, the concentration profile of the PE is represented by a solid black line and the concentration profile of the additive Irgafos® 168 is represented by the dotted line. The concentrations along the entire length of the bed are given as a weight percentages of the compound followed, i.e. of PE or of the additive, relative to the weight of the heptane.

From FIG. 3, it is apparent that the polyethylene (PE), which does not explore the intragranular porosity, is entrained towards the raffinate and withdrawn between bed 13 and bed 14. Since the additive is smaller, it can diffuse into the intragranular porosity and is entrained towards the extract, withdrawn between bed 6 and bed 7.

The step of PE extraction performed in a simulated moving bed makes it possible to obtain the following performance qualities:
Polyethylene purity=99.99% by weight (which corresponds to the weight, or flow rate by weight, of PE in the raffinate relative to the total weight, or total flow rate by weight, of PE and additive in the raffinate, excluding solvent, i.e. excluding heptane)
Polyethylene yield=100% (by weight) (which corresponds to the flow rate by weight of PE withdrawn in the raffinate divided by the flow rate by weight of PE withdrawn in the combination of extract+raffinate)
Productivity=170 kg of PE withdrawn in the raffinate/h/m³ of silica gel bed

The raffinate at the outlet of the simulated moving bed for extraction by size exclusion may then be recovered and sent into a polymer-solvent separation section, in particular a section for evaporation of the solvent heptane.

1. Process for purifying a plastic feedstock in order to obtain a stream of purified polyolefins, said process comprising:
a) a dissolution step comprising bringing the plastic feedstock into contact with a dissolution solvent, in order to obtain at least one crude polymer solution;
b′) optionally a step of separation of the insoluble materials from the crude polymer solution obtained from step a), in order to obtain at least one clarified polymer solution;
b) a step of extraction by size exclusion of the crude polymer solution obtained at the end of step a) or optionally of the clarified polymer solution obtained at the end of optional step b′), in order to obtain a purified polymer solution,
wherein said step of extraction by size exclusion implements at least one train of n fixed beds of a size exclusion solid, n being an integer greater than or equal to 4, the n beds being in series,
said train of fixed beds of step b) being fed with crude or optionally clarified polymer solution at at least one point of injection F of the polymer solution and with an eluent at at least one point of injection S of the eluent,
wherein said train of fixed beds of step b) implements at least one withdrawal of an extract at at least one point of withdrawal E of the extract, and at least one withdrawal of a raffinate at at least one point of withdrawal R of the raffinate,
wherein the points of injection of the polymer solution and of the eluent and the points of withdrawal of the extract and of the raffinate are distinct from one another and distributed so that they determine at least three, preferably four, successive main operating zones of the n fixed beds:
a zone I of elution of the impurities, located between a point of injection of the eluent and a point of withdrawal of the extract;
a zone II of elution of the polyolefins, located between the point of withdrawal of the extract and a point of injection of the polymer solution;
a zone III of retention of the impurities, located between the point of injection of the polymer solution and a point of withdrawal of the raffinate; and
optionally a zone IV, located between the point of withdrawal of the raffinate and the point of injection of the eluent,
wherein the points of injection and of withdrawal are shifted over time by one fixed bed of size exclusion solid according to a frequency determined by a predetermined permutation period,
wherein said raffinate is recovered in order to constitute, at least in part, the purified polymer solution;
c) a step of polymer-solvent separation of the purified polymer solution, in order to obtain at least one stream of purified polyolefins and at least one solvent fraction comprising dissolution solvent.

2. Process according to claim 1, wherein the dissolution solvent comprises at least one hydrocarbon compound, which is preferably aliphatic and in particular paraffinic, having a boiling point of between-50 and 250° C., preferably between-15 and 150° C., preferentially between-1 and 110° C. and with preference between 2° and 100° C., very preferably an aliphatic paraffinic hydrocarbon compound, containing between 3 and 12 carbon atoms and very preferably between 4 and 8 carbon atoms.

3. Process according to claim 1, wherein the eluent is of the same chemical nature as the dissolution solvent.

4. Process according to claim 1, wherein step b) of extraction by size exclusion implements at least one train of n fixed beds of a size exclusion solid, n being an integer of between 4 and 30 and preferably between 12 and 15.

5. Process according to claim 1, wherein the size exclusion solid is a porous solid having a volume-average pore diameter of between 1 and 500 nm, preferably between 2 and 100 nm, preferentially between 2 nm and 50 nm, preferentially between 3 and 30 nm.

6. Process according to claim 1, wherein the size exclusion solid comprises a silica gel, a grafted silica, a carbon molecular sieve or mixtures thereof.

7. Process according to claim 1, wherein the eluent and the polymer solution feed step b) according to a ratio of the flow rates by volume of the eluent in relation to the polymer solution of between 0.1 and 50.0, preferably between 0.2 and 10.0, preferably between 0.5 and 5.0, preferentially between 0.8 and 2.0.

8. Process according to claim 1, wherein the points of injection of the polymer solution and of the eluent and the points of withdrawal of the extract and of the raffinate are located between two consecutive beds or optionally upstream of the first bed.

9. Process according to claim 1, wherein the n beds of size exclusion solid operate in a closed loop and are distributed in four main operating zones, the zones I to IV, according to a configuration of a/b/c/d type, the distribution of the beds of size exclusion solid in the zones I to IV, with respect to the total number n of beds of size exclusion solid, being preferably such that:
a is the number of beds of size exclusion solid in zone I,
b is the number of beds of size exclusion solid in zone II,
c is the number of beds of size exclusion solid in zone III, and
d is the number of beds of size exclusion solid in zone IV,
and wherein:
$$a = ( n * 0.3 ) * ( 1 \pm 0.4 , preferably 1 \pm 0.3 ) ,$$
$$b = ( n * 0.15 ) * ( 1 \pm 0.4 , preferably 1 \pm 0.3 ) ,$$
$$c = ( n * 0.25 ) * ( 1 \pm 0.4 , preferably 1 \pm 0.3 ) , and$$
$$d = ( n * 0.3 ) * ( 1 \pm 0.4 , preferably 1 \pm 0.3 ) .$$

10. Process according to claim 1, wherein the n beds are in a closed loop and the permutation period is preferably adjusted so as to define a cycle time, which corresponds to the period of time required for the points of injection and of withdrawal to return to their initial position, of between 1 and 600 minutes, preferably between 5 and 200 minutes, with preference between 10 and 90 minutes.

11. Process according to claim 1, wherein step a) is performed at a dissolution temperature of between 100° C. and 300° C., preferably between 15° and 250° C., and a dissolution pressure of between 1.0 and 100.0 MPa absolute, preferably between 1.0 and 25.0 MPa absolute, preferably between 1.5 and 18.0 MPa absolute and very preferably between 2.0 and 15.0 MPa absolute.

12. Process according to claim 1, wherein step a) is fed with the plastic feedstock and the dissolution solvent in a weight ratio between the dissolution solvent and the plastic feedstock of between 0.2 and 100.0, preferably between 0.3 and 20.0, with preference between 1.0 and 10.0, more preferentially between 3.0 and 7.0.

13. Process according to claim 1, wherein step b) of extraction by size exclusion of step b) is performed at a temperature of between 100° C. and 300° C., preferably between 15° and 250° C., and at a pressure of between 1.0 and 100.0 MPa absolute, preferably between 1.0 and 25.0 MPa absolute, preferably between 1.5 and 18.0 MPa absolute and very preferably between 2.0 and 15.0 MPa absolute.

14. Device for extraction by size exclusion of polyolefins from a polymer solution, said device comprising:
n fixed beds of a size exclusion solid, n being an integer greater than or equal to 4, preferably of between 4 and 30, said size exclusion solid having a volume-average pore diameter of preferably between 1 and 500 nm, preferably between 2 and 100 nm, preferentially between 2 nm and 50 nm, preferentially between 3 and 30 nm, and with preference being a silica gel, a grafted silica, a carbon molecular sieve or mixtures thereof,
the n fixed beds of the size exclusion solid being distributed in one or more column(s), the n beds being connected in series and preferably in a closed loop,
N systems for injection of the polymer solution, N systems for injection of an eluent, N systems for withdrawal of an extract and N systems for withdrawal of a raffinate, N being an integer preferably equal to n, said injection and withdrawal systems being located between two consecutive beds or optionally upstream of the first bed,
wherein the systems for injection of the polymer solution and of the eluent and/or the systems for withdrawal of the extract and of the raffinate which are located at one and the same position are distinct or identical,
each injection and withdrawal system comprising at least one valve suitable for allowing or not allowing the passage of a stream of polymer solution and/or of eluent and/or of extract and/or of raffinate, preferably a series of on-off valves which are controlled by an automatic sequence, or a single rotary valve, so as:
to define, at an instant t, a point of injection of the polymer solution, a point of injection of the eluent, a point of withdrawal of the extract and a point of withdrawal of the raffinate, said points of injection and of withdrawal being distinct from one another and determining at least three, preferably four, successive main operating zones of the n fixed beds:
a zone I of elution of the impurities, comprised between a point of injection of the eluent and a point of withdrawal of the extract;
a zone II of elution of the polyolefins, comprised between the point of withdrawal of the extract and a point of injection of the polymer solution;
a zone III of retention of the impurities, comprised between the point of injection of the polymer solution and a point of withdrawal of the raffinate; and
optionally a zone IV, comprised between the point of withdrawal of the raffinate and the point of injection of the eluent,
and to make possible, over time, a shifting in the points of injection and of withdrawal, synchronously or non-synchronously, according to a frequency determined by a predetermined permutation period, by one fixed bed of size exclusion solid per permutation period.

15. Device for treatment of a plastic feedstock in order to obtain a stream of purified polyolefins, comprising:
dissolution means for bringing the plastic feedstock and a dissolution solvent into contact, so as to dissolve at least in part the plastic feedstock in a dissolution solvent, in order to obtain a crude polymer solution;
optionally solid-liquid separation means suitable for separating insoluble materials in suspension in the crude polymer solution;
at least one device for extraction by size exclusion according to claim 14;
means for separation of the dissolution solvent and optionally of the eluent from a stream of purified polyolefins.
